(19) United States
(12) Patent Application Publication
(10) Pub. No.: US 2007/0016799 A1
(43) Pub. Date: Jan. 18, 2007

(54) DRAM to mass memory interface with security processor

(75) Inventors: Jani J. Klint, Tampere (FI); Matti Floman, Kangasala (FI); Jukka-Pekka Vihmalo, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/182,940

(22) Filed: Jul. 14, 2005

(51) Int. Cl. G06F 12/14; H04L 9/32; G06F 11/30

(52) U.S. Cl. 713/189; 713/193; 713/192

(57) ABSTRACT

A circuit has a first memory, which may be a flash memory or a mass memory, and a random access memory RAM that is distinct from the first memory. A central processing unit CPU couples the first memory to the RAM. Means for encrypting and decrypting in the circuit couples the first memory to the RAM, and is for encrypting and decrypting data between the first memory and the RAM autonomously of the CPU. Preferably, a microprocessor is the means for encrypting and decrypting, and operates to also autonomously read and write to and from, as well as erase from, the RAM. The CPU may be coupled to the first memory and the RAM directly or only through the means for encrypting and decrypting. A device, method, and computer program product are also detailed.

### CROSS-REFERENCE TO RELATED APPLICATION

This application is related to U.S. patent application Ser. No. 10/659,067, filed on Sep. 10, 2003 by inventor Jani Klint.

### TECHNICAL FIELD

The present invention relates generally to computing system architectures and more especially to the relative disposition of execution memory in relation to main or mass memory. It is particularly directed to encryption and decryption of data between flash or mass memory and volatile random access memory VRAM while bypassing a main processor and application specific integrated circuit(s).

### BACKGROUND

In current computer architectures, the execution memory is directly connected to the central processing unit CPU for fast access to and execution of computer program instructions. Commonly repeated data bytes are copied by the CPU from a mass memory to the execution memory so that a program may run faster in that the execution memory enables faster read/write access. Mass storage is distinct from execution memory in that mass storage retain data even when the computer is turned off, but execution memory does not retain data in a de-powered state. Mass memory as used herein refers to physical memory of a computing device from which are copied application-specific instructions to the execution memory. Often, main memory (relatively fast compared to mass memory) is used to refer to memory internal to a computing device (e.g., hard disk or memory chips) and mass memory is used to refer to an array of storage disks or computer readable tapes external to the device. In portable electronic devices such as mobile stations, the main memory is predominantly random access memory RAM and flash memory is used for read only memory ROM (non-volatile). Typically mass memory is non-volatile, inexpensive and relatively large capacity. Flash memory also retains data when de-powered, by design. Flash memory is non-volatile, and its commands are often copied to execution memory for faster read/write access.

Usually, the execution memory is dynamic random access memory (DRAM), though static random access memory (SRAM) is also used but to a lesser extent due to its cost premium over DRAM. SRAM is faster and more reliable than DRAM because it doesn't need to be refreshed. For example, DRAM typically Supports access times of about 60 nanoseconds and requires a pause between separate accesses (resulting in a high cycle time), whereas SRAM allows access times as low as ten nanoseconds and has a much lower cycle time because a pause between accesses is unnecessary. Other types of volatile random access memory (VRAM) may also be used for execution memory, such as pseudo-static RAM PSRAM such as Cellular RAM (low power like SRAM but lower cost per bit than SRAM), and UtRAM (single transistor pseudo RAM), which brings DRAM cells to the SRAM bus. Data stored in VRAM is written from the mass or flash memory to put specific instructions in a more quickly accessible location. Once the application is no longer in use, the execution memory is used for a different application and the instructions previously stored there are replaced by a new set recalled from the mass memory. Once the host device is de-powered, execution memory is cleared, and re-booting of the device at power on occurs typically from a non-volatile memory (which may or may not be copied to VRAM on powering up).

An application specific integrated circuit ASIC is a chip (integrated circuitry embedded on a semiconductor) that is designed for a particular application. ASICs are typically built by connecting existing circuit building blocks, selected from a library that has been built up by manufacturers over time, in new ways for a particular purpose. This has proven to be more economical in meeting the needs of new applications than designing a new ASIC from scratch. The ASIC or other digital controller control access to the VRAM memory by means of a chip enable line (CE) to activate the circuit, as well as various read/write and address lines directly coupling the ASIC to the RAM embodiments. Thus, all activity into and out of the execution memory goes through the ASIC or the CPU.

The inter-relational architecture of the main memory, ASIC, and volatile RAM (DRAM) are shown in FIG. 1, a prior art block diagram of connections between those components. For convenience of illustration, all components save the main memory 20 are disposed on a motherboard 22. All access to the DRAM 24 is through the central processing unit CPU 26 or the ASIC 28. In typical portable electronic devices such as mobile stations that employ an ASIC, one or more processors are inside the ASIC. To avoid confusion between different processors in a single device, the term CPU refers herein to the main, central processing unit of the overall device. Typically, the CPU has a much greater capacity in both computational capability and sometimes also speed as compared to other processors in a device, because those other processors are dedicated to particular and limited functions. For example, the processor(s) in an ASIC operate for the specific application of the ASIC (e.g., signal processing in a mobile station) and do not perform other functions such as coordinating inputs at a keypad with other applications that are affected and graphics displayed in response at a LCD screen. Where a device includes an ASIC but no separate CPU, the CPU referred to herein lies within the ASIC.

Commands being transferred from semi-permanent storage at the main memory 20 or permanent storage at the (non-volatile) flash memory 30 pass through either a mass memory bus 29a, 29b or a flash memory bus 31a, 31b and through either the ASIC 28 or CPU 26 before being written to the DRAM 24 for execution. The control unit of the CPU 26 extracts instructions from the main memory 20, copies them to the DRAM 26 via a DRAM bus 33 that directly couples the CPU 26 to the DRAM 24, and from there decodes and executes them, calling on the arithmetic logic unit ALU of the CPU 26 when necessary. While not shown, another DRAM bus may directly couple the ASIC 28 to the DRAM. Where the CPU 26 or ASIC 28 is otherwise occupied with other processing, the transfer of data to the DRAM 24 is delayed. This results in a bit of a data bottleneck at the CPU 26 or ASIC 28 when those components are under high demand.

What is needed in the art is an architecture whereby the ASIC 28 or CPU 26 can execute commands from the DRAM or perform other functions while other commands or data from main memory 20 are copied to the DRAM 24 or other fast-access executable memory.

### SUMMARY

The foregoing and other problems are overcome, and other advantages are realized, in accordance with the presently described embodiments of these teachings.

In accordance with one aspect, the invention is a circuit that has a first memory, which is preferably a non-volatile memory such as a flash memory. The circuit further has a random access memory RAM that is distinct from the first memory. That the first and RAM memory are distinct merely means they are categorically distinguishable; they may be disposed on a common substrate but be of different memory types; they may be distinct memory chips mounted to the same motherboard, or they may be spaced from one another and of disparate physical or logical types. The circuit further has a central processing unit CPU coupled to the first memory and to the volatile RAM. Means for encrypting and decrypting in the circuit couples the first memory to the RAM, and is for encrypting and decrypting data between the first memory and the RAM autonomously of the CPU. Preferably, a microprocessor serves as the means for encrypting and decrypting, and operates to also autonomously read and write to and from, as well as erase from, the RAM. The RAM may be volatile or non-volatile.

In accordance with another aspect, the invention is a device that has a first memory and a random access memory RAM that is distinct from the first memory. A microprocessor of the device is coupled between the first memory and the RAM for encrypting and decrypting data between the first memory and the RAM autonomously of any CPU and ASIC of the device. The microprocessor is further for reading and writing data between the RAM and the first memory autonomously of any CPU and ASIC of the device.

In accordance with another aspect, the invention is a method of operating an executable memory. In the method, a first string of executable code is copied from a first memory to an executable memory using a first data path. The first string of executable code is executed from the executable memory by a processor using a second data path, but the processor that executes the code does not lie along the first data path. A second string of data is copied and encrypted from the first memory to the executable memory using the first data path. Thus, the copying and encrypting are not done by the processor that executes that first string of computer program code.

In accordance with another embodiment, the invention is a program of machine-readable instructions, tangibly embodied on an information bearing medium and executable by a microprocessor, to perform actions directed toward copying and encrypting data. In this program, the actions include reading data from a first memory, encrypting that data, and writing the encrypted data to a random access memory RAM. Each of those above actions are performed by the microprocessor autonomously of any central processing unit and any application specific integrated circuit within the device in which the microprocessor is disposed.

Further details of various embodiments of the invention are described below.

### BRIEF DESCRIPTION OF THE DRAWINGS

The foregoing and other aspects of these teachings are made more evident in the following Detailed Description, when read in conjunction with the attached Drawing Figures, wherein:

FIG. 1 is a prior art block diagram of various memories, a CPU, and an ASIC of a computing device.

FIG. 2 is a block diagram of various memories, a CPU, and an ASIC according to a first embodiment of the present invention.

FIG. 3 is a block diagram of various memories, a CPU, and an ASIC according to a second embodiment of the present invention.

FIG. 4 is a block diagram of various memories, a CPU, and an ASIC according to a third embodiment of the present invention.

FIG. 5 is a clock diagram of a mobile station in which the present invention as shown in FIGS. 2-4 may be embodied.

### DETAILED DESCRIPTION OF EMBODIMENTS OF THE INVENTION

One approach to ease the bottleneck caused by the CPU or ASIC controlling all access to the DRAM is described in U.S. Patent Application Publication No. 2004/0136259 A1, published on Jul. 15, 2004, entitled “Memory Structure, A System, and an Electronic Device, as Well as a Method in Connection with a Memory Circuit”, by co-inventor Jani Klint. That publication describes a memory controller disposed between a NAND flash memory and a DRAM by which access to the DRAM is available without passing through the CPU or ASIC. That publication is hereby incorporated by reference.

Another related disclosure is U.S. Patent Application Publication No. 2004/0010671 A1, published on Jul. 15, 2004, entitled “Method and Memory Adapter for Handling Data of a Mobile Device Using Non-Volatile Memory”, by co-inventor Jukka-Pekka Vihmalo, and others. That publication describes a memory adapter coupled to a non-volatile memory and a fixed memory of a mobile device for handling data in the fixed memory.

The invention described in U.S. Patent Application Publication No. 2004/0136259 A1 eases the data bottleneck described above. There is also a need to enable certain processes such as secure data transfers. The present invention bolsters the memory controller of U.S. Patent Application Publication No. 2004/0136259 A1 with a microcontroller between the mass memory and the DRAM, or between the flash memory and the DRAM, preferably between both. Such a microcontroller is enabled to autonomously read, write, and erase between the execution memory and the mass storage memory or flash memory, but the microcontroller further autonomously performs encrypting and decrypting functions related to the moving of data or instructions between memory devices. Optionally, the microcontroller contains a tamper resistant module TRM, which typically store a user's private key for use in encrypting and decrypting data according to a public/private key pair data security regimen. Such a TRM enables secure e-commerce as well using public key infrastructure PKI, for devices that have capacity to communicate with a network such as the Internet, without having all encryption/decryption of data pass through the ASIC as is typical in the prior art. While the volatile memory is described as DRAM, it may also be SRAM or PSRAM or other fast-access memory known in the art. While the DRAM is volatile in that is loses its data when de-powered, it will be apparent that the present invention is operable with volatile or non-volatile RAM, and is detailed below with respect to volatile DRAM as an example.

A first exemplary embodiment of the present invention is shown in block diagram at FIG. 2. Certain components are disposed on a motherboard 22 for convenience of illustration. A mass memory 20a, CPU 26, ASIC 28, and flash memory 30a are known in the art. Disposed between the DRAM 24a or other type of VRAM is a separate microcontroller 32a that controls access to the DRAM 24a while bypassing both the CPU 26 and ASIC 28 (if present). Data from the flash memory 30a or mass memory 20a passes through the separate microcontroller 32a, which controls the address lines and enable lines for accessing the DRAM 24a. The separate microcontroller 32a further stores the user's private key to enable encryption and decryption of data copied to or from the DRAM 24a without sacrificing security when the CPU 26 or ASIC 28 is bypassed. The microcontroller is therefore a cryptographic means. In the embodiment of FIG. 2, a first bus 34 (shown as 34a and 34b) couples the mass memory 20a and the flash memory 30a to the separate microcontroller 32a, and a second bus 36 couples the separate microcontroller 32a directly to the DRAM 24a while bypassing the CPU 26 and ASIC 28.

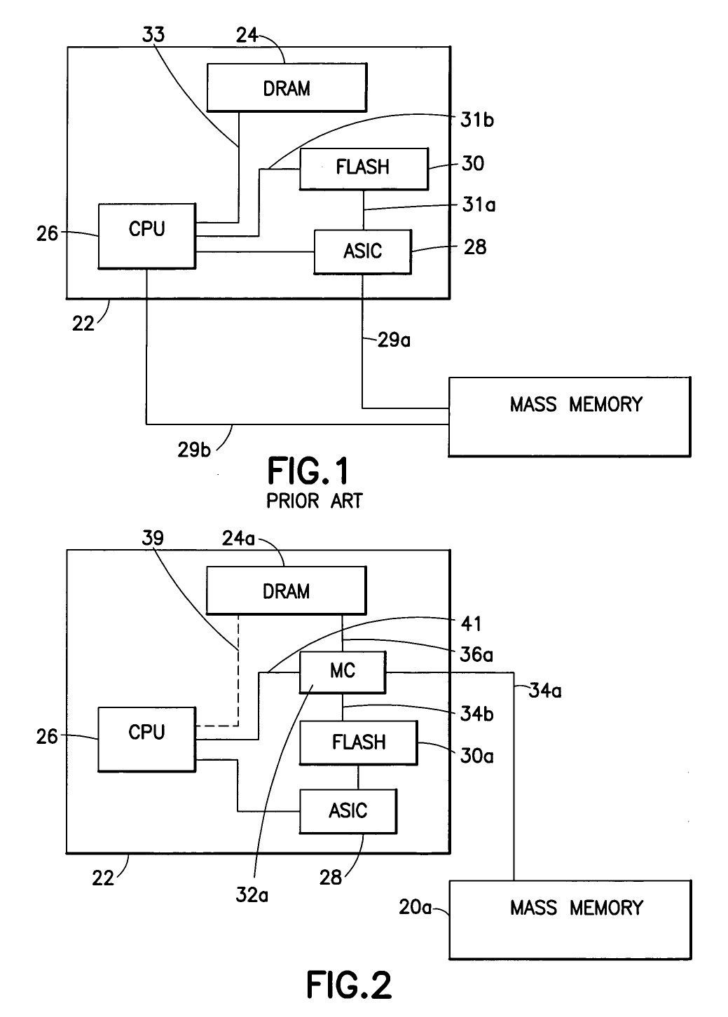

Note the contrast between the prior art FIG. 1 and FIG. 2 in that there is no mass memory bus 29a, 29b directly coupling the mass memory 20a to the ASIC 28 or CPU 26. Additionally, there is no flash memory bus 31b directly coupling the flash memory 30a of FIG. 2 with the CPU 26. In such an embodiment, the CPU 26 may read data from the mass memory 20a or flash memory 30a through the microcontroller 32a. In one embodiment as illustrated, a control bus 41 is used for data transfer between the CPU 26 and the microcontroller 32a. In another embodiment, the CPU 26 reads data through the DRAM 24a where the DRAM 24a is a two-port device with the microcontroller 32a coupled to one port and the CPU 26 coupled to another via the dashed line DRAM bus 39 shown. The former embodiment is preferred in order not to occupy the DRAM 24a with additional data for which executable memory is not necessary. In either instance, fewer pins at the CPU are occupied in order to make the requisite connections, as is evident in the different number of busses leading to the CPU 26 in FIG. 2 as compared to prior art FIG. 1. Of course, the mass memory busses 29a, 29b and/or the flash memory busses may be retained in embodiments of the present invention.

That the control bus 41 enables the CPU 26 and the microprocessor 32 to communicate does not imply that the microprocessor 32 is slaved to the CPU 26; the microprocessor 32 operates autonomously of the CPU 26 for encryption and decryption, informing the CPU 26 of its actions respecting the DRAM 24 and coordinating read/write/erase addresses where necessary.

Where the CPU 26 can read data from the mass memory 20a or flash memory 30a by another pathway, he control bus 41 noted above is preferably only used to coordinate operations between the CPU 26 and the microcontroller 32a as such operations relate to the DRAM 24a, so as to prevent conflicting signals such as where both processors 24, 32a attempt to operate on the same memory unit of the DRAM 24a inconsistently (e.g., both processors 24, 32 attempt to write to the same memory unit). Alternative to the control bus 41, a simple register may be used to log which memory cells of the DRAM 24a are in use (e.g., which contain instructions currently being executed or soon expected to be executed) and which are available of erasure and writing (e.g., memory cells for which the instructions have already been executed or the relevant application has been closed). Preferably, such a register is within the DRAM 24a itself. Other means for coordinating operations on the DRAM 24a may also be used.

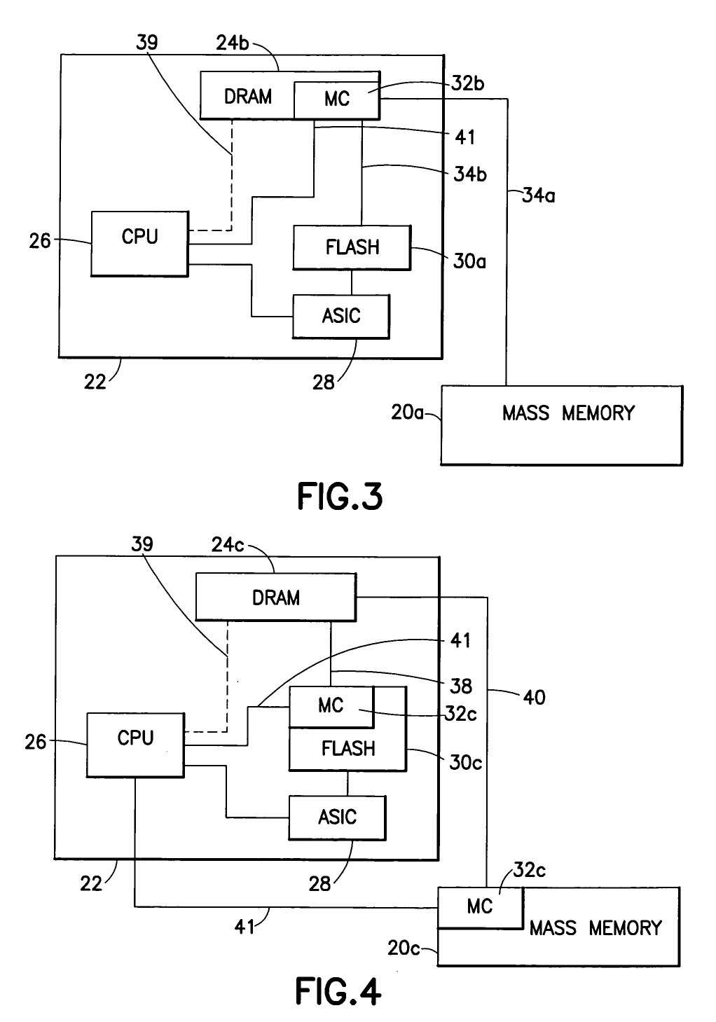

The second embodiment of FIG. 3 illustrates a resident microcontroller 32b embedded within the chip of the DRAM 24b. In this embodiment, only the first bus 34 (illustrated as 34a and 34b) is necessary to couple either of the various memories, as the first bus 34 couples the embedded microcontroller 34b to both the mass memory 20a and the flash memory 30b and directly couples to the command, input/output, and address lines of one port of the DRAM 24b. As with the first embodiment of FIG. 2, the data busses directly coupling the mass memory 20a to either the CPU 26 or the ASIC 28 are not necessary, and are not illustrated in this embodiment. A DRAM bus 39 directly couples the CPU 26 to a port of the DRAM 24b separate from the embedded microcontroller 32b, and the control bus 41 is used only for coordinating operations that affect the DRAM 24b.

The third embodiment is shown in FIG. 4, wherein a resident microcontroller 34c is embedded in each of the flash memory 30c and the mass memory 20c. In certain variations of this third embodiment, only the flash memory 30c or the mass memory 20c has a resident microcontroller 32c embedded thereon. One bus 38 couples the resident microcontroller 32c of the flash memory 30c to the DRAM 24, and another separate bus 40 couples the resident microcontroller 32c of the mass memory 20c to the DRAM 24. Access to the command, input/output, and address lines of the flash memory 30c and mass memory 20c is directly through their respective embedded microcontrollers 32c. Where the DRAM 24c is a two-port device with the CPU 26 coupled to one port through a DRAM bus 39 directly, access to the command, input/output, and address lines of the other port of the DRAM 24 is by the relevant microcontroller 32c that is controlling access to that other port of the DRAM 24. In certain embodiments, the control bus 41 may also enable the CPU to check the flash memory or mass memory for quality parameters such as wear leveling of memory unit erasure cycles to extend memory device life. Where a register or other means for coordinating access to the DRAM 24c is used, a control bus for that purpose may still be used.

The second embodiment, shown in FIG. 3, is seen as preferential for portable electronic devices as it is the most space efficient. The resident microcontroller 32b may be embedded in the DRAM die (FIG. 3), or in the NAND flash or mass memory die (FIG. 4). One satisfactory embodiment for the microcontroller is the ARM7TDMI processor, available through Advanced RISC Machines Ltd of the United Kingdom. Other capable microprocessors are also available. Generally, the microprocessor should lie within an area of about 5 mm², including some allowance for a microprocessor memory cache separate from those memories already detailed. The ARM7TDMI chip occupies about 0.25 mm² without cache, in standard fabrication. It is anticipated that embedding the ARM7TDMI in a DRAM die will increase the size over o.25 mm² due to fewer metal layers in the DRAM die, with some allowance for microprocessor cache increasing the total size to a few square millimeters.

The microcontroller 32a, 32b, 32c interfaces directly to the mass/flash storage interface and internally to the DRAM 24a, 24b, 24c device in order to handle the data transactions between the two memories. Conflicts between the microcontroller 32 and the CPU or ASIC may be handled by a bus between them to avoid conflicting signals at the DRAM 24, such as by the control bus 41 or register previously described. Alternatively the CPU 26 can be also used to encrypt/decrypt portions of the mass storage 20 or flash memory 30 and the microcontroller 32a, 32b, 32c can be used to encrypt/decrypt other portions. Further the CPU 26 could also have an interface to the system ASIC if system ASIC needs to directly access the mass storage 20 or flash 30 memory as shown in each of FIGS. 2-4, for devices that use both an ASIC and a CPU.

The following examples describe operation of the present invention. Assume in a first example that the device in which the present invention is embodied is powered on. Immediately prior to power on, the DRAM 24 is empty as it does not store data in a power-off condition, and the flash memory 30 stores a boot program and commands to load other application programs stored on the mass memory 20. Such programs and commands were previously loaded onto the flash memory 30 when the host device was powered, and are retained in the power off mode. Assume for this example that the CPU 26 resolves conflicts with the microprocessor 32 via the control bus 41, so that both do not attempt to write to the same memory unit of the DRAM 24 at the same instant. Once operating voltage is applied to the CPU 26 and the other components of FIGS. 2-4, assume that in this example the CPU 26 loads only the boot program to the DRAM 26, and runs it. While the CPU 26 runs the boot program, the microprocessor 32 sets the control lines of the DRAM 24 in a state where data transmission is enabled between the flash memory 30 and the DRAM 24. Via the control bus 41, the microprocessor knows not to erase or overwrite those storage units of the DRAM at which the boot program is stored. The microprocessor 32 then sets the memory address of the application programs to be loaded into the DRAM 24, sets the control signals, and begins the data transmission. These programs are apart from the already-loaded boot program, and may be additional applications selected by a user to open upon start-up. The microcontroller 32 in this instance operates as the memory controller of U.S. Patent Application Publication No. 2004/0136259 A1, reading data byte by byte from the flash memory 30 and copying it to the DRAM 24. After each block (32 bytes) of data is copied, the microcontroller 32 informs the CPU 26 via the control bus 41 that the block is written to the DRAM 24. Alternatively, the microcontroller 32 informs the CPU 26 after all executable data in a segment (e.g., a stand-alone program) is copied. The CPU 26 is thus free to run another program, while the microcontroller coordinates copying executable code to the DRAM 24 for actual execution at a later time by the CPU 26. In this embodiment, the DRAM 24 is a dual-port module so that both the CPU 26 and the microcontroller 32 may simultaneously access it; the CPU for executing code and the microprocessor for copying code that will be executed by the CPU 26 once copied. The dual ports are illustrated in FIGS. 2-4 by the separate links to the CPU 26 and the flash memory 30.

Assume in a second example that the host device is already powered, and coupled via a wireless link to an Internet site for which a secure transaction is to be made. Stored in a tamper resistant module TRM of the microcontroller 32 is a private key used to ensure transaction security, based on a previous transaction between the host device and the Internet site. In response to the user accessing an e-commerce portion of the Internet site, the microcontroller 32 loads, from the mass memory 20 or flash memory 20 to the DRAM 24, a reply message. The microprocessor 32 in this instance encrypts the reply message with the public/private key pair previously used with this site, but the private key is within the TRM module of the microcontroller 32. Meanwhile, the CPU 26 is freed for other uses such as signal processing when the link to the Internet site is wireless, and delays in passing all e-commerce data through the CPU 26 are avoided or at least mitigated. Thus, the data written by the microcontroller 32 to the DRAM 24 is encrypted, and security is not compromised by sending unencrypted data when bypassing the CPU 26 with the present invention. Absent the present invention, the CPU 26 would have to complete its signal processing or other disparate functions before the reply message can be encrypted and written to the DRAM 24, causing a bottleneck as described above and in U.S. Patent Application Publication No. 2004/0136259 A1.

The present invention may be considered as operations (especially encryption/decryption operations) along different data paths, whereas the prior art uses a different set of data paths or only one data path. An important difference between the prior art and embodiments of the present invention is the decrypting of data/code from the mass memory to the RAM and encrypting of data/code from the RAM to the mass memory. A first string of executable code is copied from the flash 30 or mass memory 20 to an executable memory, the DRAM 24, using a first data path. The first data path illustrated in FIG. 2 is the first bus (either 34a or a combination of 34b with a portion of 34b) that passes through the microcontroller 32a and the second bus 36a that goes to the DRAM 24. As detailed above, the executable code (the first string) that was copied to the DRAM 24 via the first path may then be executed by the CPU 26. Clearly, the CPU 26 is not along the first data path. To add the encryption aspect of the microcontroller, a second string of data is copied from the first memory, encrypted, and written as encrypted to the executable memory using the first data path. Executing the first string of executable code may be done simultaneously with copying and encrypting the second string of data, as enabled above with the control bus 41 that allows the CPU 26 and the microprocessor 32 to coordinate their respective actions in the DRAM 24. This control bus 41 clearly couples the first and second data paths detailed above. Decryption proceeds in the opposite direction. The above is not to imply that all encryption/decryption must go through the microprocessor 32. As noted above, some data strings may be encrypted/decrypted by the microprocessor 32 and others by the CPU 26 using a third data path that goes from the mass memory 20 to the DRAM 24 via the CPU 26. The data line directly between the CPU 26 and the DRAM 24 represents a partial overlap of the second and third data paths in the above characterization of data pathways of the present invention.

The same functionality operates in the reverse data flow. Where the CPU 26 is busy with some other function, the microprocessor may read encrypted data from the DRAM 24, decrypt it using the private key stored in the TRM (or other cryptographic techniques), and copy the decrypted data to the mass memory 20 which can then be readily displayed without high demand on the CPU 26.

The present invention is advantageously disposed within a mobile station. A mobile station MS is a handheld portable device that is capable of wirelessly accessing a communication network, such as a mobile telephony network of base stations that are coupled to a publicly switched telephone network. A cellular telephone, a Blackberry® device, and a personal digital assistant (PDA) with Internet or other two-way communication capability are examples of a MS. A portable wireless device includes mobile stations as well as additional handheld devices such as walkie talkies and devices that may access only local networks such as a wireless localized area network (WLAN) or a WIFI network.

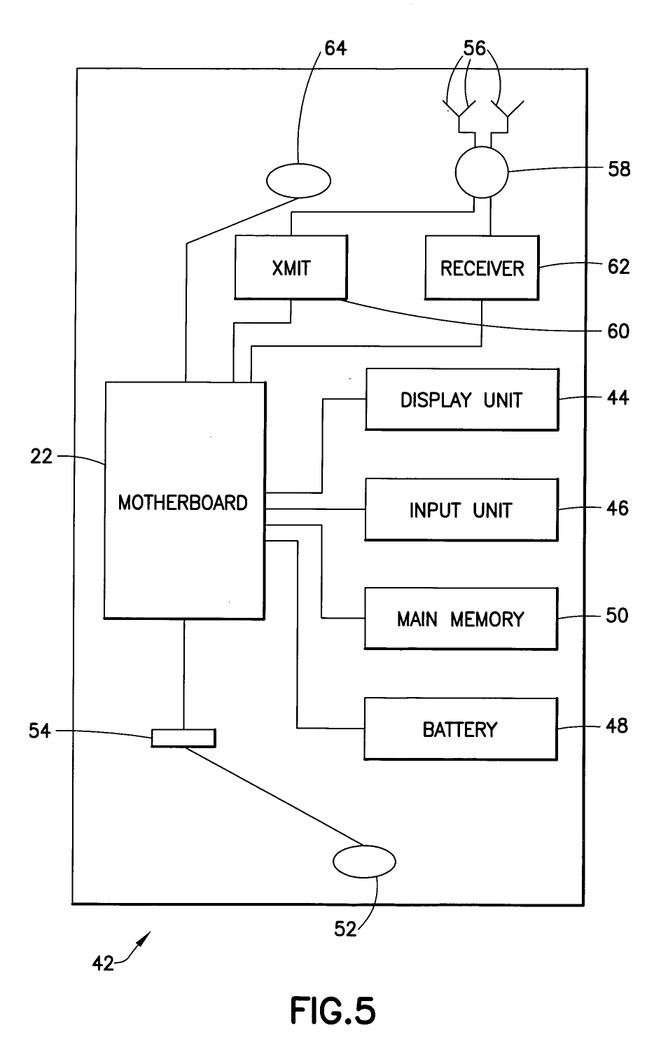

FIG. 5 illustrates in block diagram form such a mobile station MS 42 in which the present invention may be disposed. These blocks are functional and the functions described below may or may not be performed by a single physical entity as described with reference to FIG. 5. A display unit 44 (e.g., display driver and LCD screen), and a user input unit 46 (e.g., keypad, touch sensitive screen, etc), are provided for interfacing with a user. The MS 42 further includes a power source 48 such as a self-contained battery that provides electrical power to a motherboard 22 that includes the central processor 26, ASIC 28, DRAM 24a, 24b, 24c, and microprocessor 32a, 32b, 32c. Within the CPU 26 are functions such as digital sampling, decimation, interpolation, encoding and decoding, modulating and demodulating, encrypting and decrypting, spreading and despreading (for a CDMA compatible MS 42), and additional signal processing functions known in the art. The flash memory 30a, 30c, may be disposed on the motherboard 22 or separately as a portion of the main memory 50.

Voice or other aural inputs are received at a microphone 52 that may be coupled to the processor through a buffer memory 54. Computer programs such as drivers for the display 44, algorithms to modulate, encode and decode, data arrays such as look-up tables, and the like are stored in a main memory storage media 50 which may be an electronic, optical, or magnetic memory storage media as is known in the art for storing computer readable instructions and programs and data. The MS 42 communicates over a network link such as a mobile telephony link via one or more antennas 56 that may be selectively coupled via a transmit/receive T/R switch 58, or a diplex filter, to a transmitter 60 and a receiver 62. The MS 42 may additionally have secondary transmitters and receivers for communicating over additional networks, such as a WLAN, WIFI, Bluetooth®, or to receive digital video broadcasts. Known antenna types include monopole, di-pole, planar inverted folded antenna PIFA, and others. The various antennas may be mounted primarily externally (e.g., whip) or completely internally of the MS 42 housing. Audible output from the MS 42 is transduced at a speaker 64.

The present invention may be embodied as a computer program of machine-readable instructions, tangibly embodied on an information bearing medium and executable by the microprocessor described above. The program causes the microprocessor to copy and encrypt data autonomously of any central processing unit or ASIC of the device in which the microprocessor is disposed, so that the microprocessor reads data from a first memory such as a mass or flash memory, encrypts that data, and writes the encrypted data to the RAM. Of course, the program may preferably also encrypt data read from the RAM and write the encrypted data to the first memory, and/or decrypt data read from the first memory and write the decrypted data to the RAM, though uses for these latter capabilities are more limited. Not all data moving between the first memory and the RAM need be encrypted/decrypted, and not all encryption/decryption need be performed by the microprocessor, each as detailed above. Write operations may be coordinated with the CPU or ASIC, such as by the control bus or register detailed above.

Whereas the present invention is not limited to mobile stations or even portable electronic devices, the following are seen as advantages and disadvantages in such an embodiment. The present invention enables a reduced pin count at the ASIC (which typically handles encryption/decryption), saving on complexity, cost and size. The present invention enables performance optimization without compromising data security because fewer transactions pass through the system ASIC. However, the encrypt/decrypt capability necessarily adds to storage transaction latency where encryption/decryption is not necessary, and adds both power and cost due to the additional microprocessor. The inventors see these disadvantages are far outweighed by the advantages, even in a portable electronic device where power consumption is a key consideration.

Although described in the context of particular embodiments, it will be apparent to those skilled in the art that a number of modifications and various changes to these teachings may occur. Thus, while the invention has been particularly shown and described with respect to one or more preferred embodiments thereof, it will be understood by those skilled in the art that certain modifications or changes may be made therein without departing from the scope and spirit of the invention as set forth above, or from the scope of the ensuing claims.

What is claimed is:

1. A circuit comprising
a first memory;
a random access memory RAM distinct from the first memory; and
a central processing unit CPU coupled to the first memory and the RAM; and
means for encrypting and decrypting, coupled between the first memory and the RAM, for encrypting and decrypting data between the first memory and the RAM autonomously of the CPU.

2. The circuit of claim 1, wherein the CPU is coupled to a first port of the RAM and the means for encrypting and decrypting is coupled to a second port of the RAM.

3. The circuit of claim 1 further comprising means for coordinating operations of the CPU and the means for encrypting and decrypting on the RAM.

4. The circuit of claim 3, wherein the means comprises one of a control bus and a register in the RAM.

5. The circuit of claim 3, wherein the means enables simultaneous operations on the RAM by the CPU and the means for encrypting and decrypting.

6. The circuit of claim 1 wherein the first memory comprises a non-volatile RAM and the said RAM comprises a volatile RAM.

7. The circuit of claim 1 wherein the first memory comprises a mass memory and the said RAM comprises a volatile RAM.

8. The circuit of claim 7, further comprising a flash memory coupled separately through the CPU and the means for encrypting and decrypting to the said RAM.

9. The circuit of claim 1 wherein the RAM comprises at least one of DRAM, SRAM, and PSRAM.

10. The circuit of claim 1, wherein the means for encrypting and decrypting comprises a separate component from each of the first memory and the RAM.

11. The circuit of claim 1, wherein the means for encrypting and decrypting comprises a microprocessor embedded with a DRAM device that comprises the RAM.

12. The circuit of claim 1, wherein the means for encrypting and decrypting comprises one of a microprocessor embedded with a mass memory device and a microcontroller embedded with a flash memory device.

13. The circuit of claim 1 wherein the means for encrypting and decrypting comprises a microprocessor.

14. The circuit of claim 11, wherein the microprocessor is further for reading to and from, writing to and from, and erasing from the RAM.

15. The circuit of claim 1 wherein the means for encrypting and decrypting comprises a microcontroller with a tamper resistant module.

16. The circuit of claim 1, wherein the CPU is coupled to the first memory and the RAM only through the means for encrypting and decrypting.

17. The circuit of claim 1, wherein the CPU is coupled directly to the first memory.

18. A device comprising:
a first memory;
a random access memory RAM distinct from the first memory; and
a microprocessor coupled between the first memory and the RAM for encrypting and decrypting data between the first memory and the RAM autonomously of any CPU and ASIC of the device, and further for reading and writing data between the RAM and the first memory autonomously of any CPU and ASIC of the device.

19. The device of claim 18, wherein the device further comprises a central processing unit CPU coupled to a first port of the RAM, and the microprocessor is coupled to a second port of the RAM.

20. The device of claim 18, wherein the device further comprises a central processing unit CPU and one of a control bus between the CPU and the microprocessor and a register in the RAM for enabling simultaneous operations on the RAM by the CPU and the microprocessor.

21. The device of claim 18, wherein the microprocessor and the RAM comprise an integrated component.

22. The device of claim 18, wherein the microprocessor and the first memory comprise an integrated component.

23. The device of claim 18, wherein the microprocessor is a separate component from each of the RAM and the first memory.

24. The device of claim 18, wherein the microcontroller comprises a tamper resistant module.

25. The device of claim 18, wherein the device further comprises a central processing unit CPU that is coupled to the first memory and the RAM only through the microcontroller.

26. A method of operating an executable memory comprising:
copying a first string of executable code from a first memory to an executable memory using a first data path;
executing the first string of executable code from the executable memory by a processor using a second data path, wherein the processor is not along the first data path; and
copying and encrypting a second string of data from the first memory to the executable memory using the first data path.

27. The method of claim 26, wherein executing the first string of executable code and copying and encrypting a second string of data is performed simultaneously using a control path coupling a microcontroller along the first data path with the processor along the second data path.

28. The method of claim 26 further comprising:
copying and encrypting a third string of data from the first memory to the executable memory by a processor using a third data path that overlaps in part the second data path.

29. A program of machine-readable instructions, tangibly embodied on an information bearing medium and executable by a microprocessor, to perform actions directed toward copying and encrypting data, the actions comprising:
autonomously of any central processing unit and any application specific integrated circuit within a device housing the microprocessor,
reading data from a first memory;
encrypting said data; and
writing said encrypted data to a random access memory RAM.

30. The program of claim 29, wherein writing said encrypted data to a random access memory comprises:
coordinating write operations on the RAM with a central processing unit of the device; and
writing the encrypted data.

31. The program of claim 30, wherein coordinating comprises checking a register in the RAM for available memory units, and wherein writing the encrypted data comprises writing only to unavailable memory units.

32. The program of claim 30, wherein coordinating comprises using a control bus between the central processing unit and the microprocessor.
